(19) United States
(12) Patent Application Publication
(10) Pub. No.: US 2008/0117054 A1
(43) Pub. Date: May 22, 2008

(54) Controlling method for a radio-frequency identification system and a transmission device thereof

(76) Inventor: Chia-Ying Tseng, Yonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/984,345

(22) Filed: Nov. 16, 2007

(30) Foreign Application Priority Data
Nov. 17, 2006 (TW) 95142575

(51) Int. Cl. G08B 13/14

(52) U.S. Cl. 340/572.4

(57) ABSTRACT

A controlling method and a transmission device are provided for improving the using distance and performance of a RFID system. The transmission device and the controlling method therefore are provided between the reader and the tag so that the strength and the using range of the RFID system are improved. Furthermore, optional and customized functions can easily be modified with the RFID system. Therefore, the RFID system of the present invention can be used in a wider range of applications.

### BACKGROUND OF THE INVENTION

1. Field of the Invention

The present invention relates to a controlling method for a radio-frequency identification system and a transmission device thereof and in particular to a radio-frequency (RF) identification system with and improved identification mechanism.

2. Description of Prior Art

In recent years, it has become necessary to manage data more efficiently, especially using automatic and semiautomatic systems in order to improve data management efficiency. Moreover, data that was previously hard to be trace is now easily processed as digital information on a computer system. The enhanced data processing capabilities contribute to saving time, reducing costs, and implementing environment-protecting management tools. Thus, automatic identification systems are rapidly developing.

Depending on the technology used, automatic identifying systems employ bar code systems, Optical Character Recognition (OCR) systems, biometric systems, smart card (integrated circuit (IC) card) and radio frequency identification (RFID) systems.

Each system of the above is optimized for specific requirements and the applications and costs are different for each of the data controllers. However, the RFID system, which uses wireless communication, is more efficient and more useful due to its advantages, such as a high reading rate, convenience of use and small dimensions of RFID system devices.

RFID basically is an automatic identification technology using RF waves. The principle of RFID is that a reader transmits wireless electromagnetic waves to a tag attached on an article, and the information contained is identified and retrieved. Please refer to FIG. 1. The RFID system comprises a reader, a tag, a host for controlling the system, and antennas for receiving and transmitting signals.

On the other hand, there are some shortcomings in the RFID system. In general, some RFID products follow the existing communication standards, such as ISO, but the RFID hardware, such as the reader and the tag, as well as the software are not standard. RFID devices of the current market are using different standards developed by individual companies. The different standards can not work with each other because their operation frequency, tag specification, data format (coding mode), identification mode, and the protocol between reader and tag are not compatible.

In addition, two interferences occur such as interference of metals and interference of other wireless devices when the reader reads from the tag.

Interference of metals occurs when the reader is disposed on a metal surface or a passive tag is attached on metal objects. The electromagnetic power of the RF wave will be reduced and reading distance and reading direction are also reduced. Comparing with another wireless transmission system, the reader of RFID system can read more than one tag, but the reader is limited to reading tags of the same type. In other words, when many types of tags operating in the same band are used in the same area, the identification of the reader will be affected because of interference.

Therefore, in view of the above, the inventor proposes the present invention to overcome the above problems based on his expert experience and deliberate research.

### SUMMARY OF THE INVENTION

The primary object of the present invention is to provide a transmission device for a RFID system. The transmission device operates inside an RFID system so that the identification of the RFID system can be more precise and the interference of other signals is reduced.

In order to better understand the characteristics and technical contents of the present invention, a detailed description thereof will be made with reference to the accompanying drawings. However, it should be understood that the drawings and the description are illustrative and not to be used to limit the scope of the present invention.

### BRIEF DESCRIPTION OF THE DRAWINGS

FIG. 1 is a schematic view of the RFID system in the prior art;

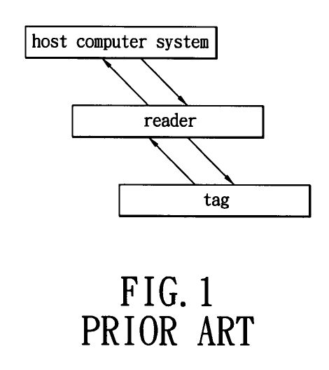

FIG. 2 is a schematic view of the RFID system according to the present invention; and

FIG. 3 shows the method of the RFID system according to the present invention.

### DETAILED DESCRIPTION OF THE INVENTION

In view of development of the wireless transmission technology, engineers focus on increasing the transmission distance and improving the transmission quality. Furthermore, the solution for low-power signals and interference of signals always are chief concern in the study of wireless communication.

The reader of the RFID system is categorized into fixed module and portable module. The user can choose a kind of the reader for objects in different usage so that the object is identified precisely.

As a result, the reader connects with a host computer system so that communication, identification and management are proceeding. It also follows that real-time monitoring and automatic application of data are achieved. The integrated effect is provided for many kinds of managements and monitoring applications, such as retailing management, storehouse management, security management, automatic production management, medical treatment management, transportation management, and shipping baggage monitoring.

RFID system further has some advantages, for example, high identifying rate, high precision of data reading, high data security, and long identifying distance. The properties of the tag are also improved. The life-time of the tag is longer and it is more convenient for using the tag. The capacity of tag is increased for satisfying high storage demands. Therefore, RFID is provided preferably in management and identifying and checking mechanism.

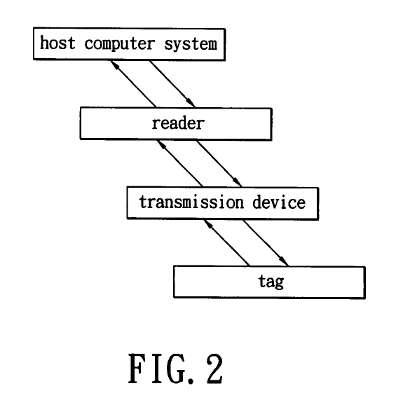

Please refer to FIG. 2, a transmission device is connected between the reader and the tag. The transmission device can relate to the parameters of the host computer so that the transmission device sends the signal to the tag depending on the demands of the system after having received the signal from the reader. The strength of signal is powered by the transmission device so as to reduce interference and to improve the identification. Secondly, the signals can be integrated with other communication protocols by setting respective parameters on the host computer. Furthermore, the customized identification can meet different management requirements. Still further, the ability to identify objects in different frequency bands can be added to the transmission device so that the application scope of the RFID system is increased.

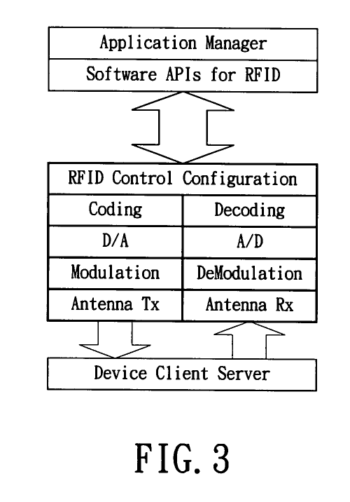

Please refer to FIG. 3. An application manager is provided for controlling the functions of the software, and the software provides an application programming interface (API) for RFID so that other software can be integrated with the system through the RFID API. The RFID control configuration corresponds to the parameter settings of the RFID system, such as scanning frequency, interval of the timing and so on. The transmission device comprises a receiving end and a transmitting end. The receiving end has a receiving antenna (Antenna Rx), a signal demodulator (Demodulation), an analog to digital device (A/D) for transforming analog signals to digital, and a signal decoder (decoding). The transmitting end includes a signal encoder (coding), a digital to analog device (D/A) for transforming digital signals to analog, a signal modulator (modulation) and a transmitting antenna (Antenna Tx).

Although the present invention has been described with reference to the foregoing preferred embodiment, it shall be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. A controlling method for a radio-frequency identification system operating between a reader and a tag, the controlling method comprising: transmitting a signal from the reader to a transmission device; setting parameters of the transmission device depending on the demands of the radio-frequency identification system after the transmission device receives the signal via a receiving antenna of the transmission device; transmitting the signal that is processed from the transmission device to the tag via a transmitting antenna of the transmission device; and simultaneously the transmission device receiving and collecting signals outputted from the tag, whereby the tag is applied in multi-function and long-path manner depending on parameters of the radio-frequency identification system.

2. A transmission device for a radio-frequency identification system operating between a reader and a tag, the transmission device comprising: a receiving end; and a transmitting end, wherein a signal outputted from the reader is received via a receiving antenna of the receiving end, the signal is processed depending on parameters set by the radio-frequency identification system, the processed signal is sent to the tag via a transmitting antenna of the transmitting end of the transmission device, and simultaneously the transmission device receives and collects a signal sent back from the tag, whereby the signal processed by the transmission device is high-power and high-identified so that the radio-frequency identification system can provide more complex identification.
